(19) United States
(12) Patent Application Publication
(10) Pub. No.: US 2016/0217508 A1
(43) Pub. Date: Jul. 28, 2016

(54) SYSTEM, METHOD AND PROGRAM PRODUCE FOR EVALUATING AN EXPERIENCE WITHIN AN ONLINE OR MOBILE REVIEW PLATFORM

(71) Applicant: Kenneth L. Poindexter, JR., Tampa, FL (US)

(72) Inventor: Kenneth L. Poindexter, JR., Tampa, FL (US)

(21) Appl. No.: 15/008,080

(22) Filed: Jan. 27, 2016

Related U.S. Application Data
(60) Provisional application No. 62/108,247, filed on Jan. 27, 2015.

(51) Int. Cl. G06Q 30/02; G06F 17/30

(52) U.S. Cl. CPC G06Q 30/0282; G06F 17/30867; G06F 17/30345; G06F 17/30882

(57) ABSTRACT

A computer implemented method is provided for scoring a plurality of linked keywords, which may include steps of obtaining a plurality of keywords from reviews, users describing their experiences using linking keywords, these linking keywords are then linked to reviews, each of the linked reviews being pointed to by a link embedded within the text or hyperlinked keyword description used to describe a business, product, service or place within a review; these linked reviews obtaining text, video, live video and audio proof an experience. Optionally, an assigned score may be provided to each of the linked keywords based on the scores of one or more of the linking keywords and processing the linked reviews according to their scores.

### CROSS-REFERENCE TO RELATED APPLICATIONS

The present Utility patent application claims priority benefit of the U.S. provisional application for patent Ser. No. 62/108,247 entitled “PHOTO AND VIDEO REVIEW MOBILE MESSAGING APPLICATION” filed on 27 Jan. 2015 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to consumer review rankings. More particularly, certain embodiments of the invention relates to consumer review ranking services.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Consumers and/or customers may often review a business and/or company by submitting a summary of any experience or events that may have occurred at the business and/or company. Typically, submitted summaries may include a written description, one or more photographs and/or videos taken by a consumer and/or customer, and/or a rating value. A person may use a computing device such as a smartphone or desktop computer to view business and/or company reviews submitted by consumers and/or customers that have been to the business and/or company in the past. The person may then decide to conduct business with and/or visit an establishment after viewing information from the business and/or company reviews such as, without limitation, a quality of service, a product or service price, and/or other consumers' ratings.

Consumer review services may include software applications operating on a computing device. Consumers and/or customers may use a consumer review application to submit a personal review for other application users to view. An application user may view all submitted reviews and/or an average review rating.

The following is an example of a specific aspect in the prior art that, while expected to be helpful to further educate the reader as to additional aspects of the prior art, is not to be construed as limited the present invention, or any embodiments thereof, to anything stated or implied therein or inferred thereupon. By way of educational background, another aspect of the prior art generally useful to be aware of is that existing consumer review tools may allow anyone to submit and/or respond to a review. Typical consumer review tools may be software applications that allow a user to access and/or navigate through a database of reviews.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for consumer review ranking, in accordance with an embodiment of the present invention;

FIG. 2 illustrates the architecture of an exemplary system for consumer review ranking, in accordance with an embodiment of the present invention;

FIG. 3 is a flow chart illustrating an exemplary process for consumer review ranking, in accordance with an embodiment of the present invention;

FIG. 4 is a flow chart illustrating an exemplary process for user input in an input module, in accordance with an embodiment of the present invention;

FIG. 5 is a flow chart illustrating an exemplary process for hashtag rating in a hashtag rating module, in accordance with an embodiment of the present invention;

FIG. 6 is a flow chart illustrating an exemplary process for Poindexter ranking in a Poindexter ranking module, in accordance with an embodiment of the present invention;

FIG. 7 is a flow chart illustrating an exemplary process for determining an experience probability in a probability module, in accordance with an embodiment of the present invention;

FIG. 8 is a flow chart illustrating an exemplary process for hashtag cloud generation in a cloud generation module, in accordance with an embodiment of the present invention;

FIG. 9 is a flow chart illustrating an exemplary process for user notification in a notification module, in accordance with an embodiment of the present invention;

FIG. 10 is a flow chart illustrating an exemplary process for displaying consumer reviews in a display module, in accordance with an embodiment of the present invention;

FIG. 11 illustrates an exemplary user interface for consumer review, in accordance with an embodiment of the present invention;

FIG. 12 illustrates an exemplary computer system that, when appropriately configured or designed, can serve as a computer system in which the invention may be embodied, in accordance with an embodiment of the present invention;

FIG. 13 is a block diagram depicting an exemplary client/server system which may be used by an exemplary web enabled or networked system, in accordance with an embodiment of the present invention;

FIG. 14 illustrates an exemplary block diagram depicting a conventional client/server communication system, in accordance with an embodiment of the present invention;

FIG. 15 illustrates an exemplary block diagram depicting exemplary keywords/hashtags in a review stream on a business listing page, in accordance with an embodiment of the present invention;

FIG. 16 is an exemplary table depicting an exemplary relationship between keyword/hashtag use and Poindexter rank, in accordance with an embodiment of the present invention;

FIG. 17 is an exemplary table depicting an exemplary relationship between keyword/hashtag use and font size, in accordance with an embodiment of the present invention;

FIG. 18 illustrates an exemplary hashtag cloud, in accordance with an embodiment of the present invention;

FIG. 19 illustrates an exemplary application of a hashtag as an html-encoded link, in accordance with an embodiment of the present invention;

FIG. 20 illustrates a bottle as an exemplary product for review, in accordance with an embodiment of the present invention;

FIG. 21A-B illustrates an exemplary product review application overlaying a photo, in accordance with an embodiment of the present invention;

FIG. 22 illustrates an exemplary live chat application, in accordance with an embodiment of the present invention;

FIG. 23 illustrates an exemplary word cloud populated with keywords/hashtags and other information, in accordance with an embodiment of the present invention;

FIG. 24A-B illustrates an exemplary messaging application, in accordance with an embodiment of the present invention;

FIG. 25 illustrates an exemplary nearby consumer detection using the consumer review system, in accordance with an embodiment of the present invention;

FIG. 26 illustrates an exemplary view of information for a business, in accordance with an embodiment of the present invention;

FIG. 27 illustrates an exemplary application of user tagging in a mobile application, in accordance with an embodiment of the present invention; and

FIG. 28 illustrates an exemplary attachment of evidence in the review application, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and/or methods for providing consumer review ranking services. Some of these embodiments may comprise computer software. In some of these embodiments, software may be integrated into hardware, including, without limitation, uniquely-designed hardware for running embodiment software.

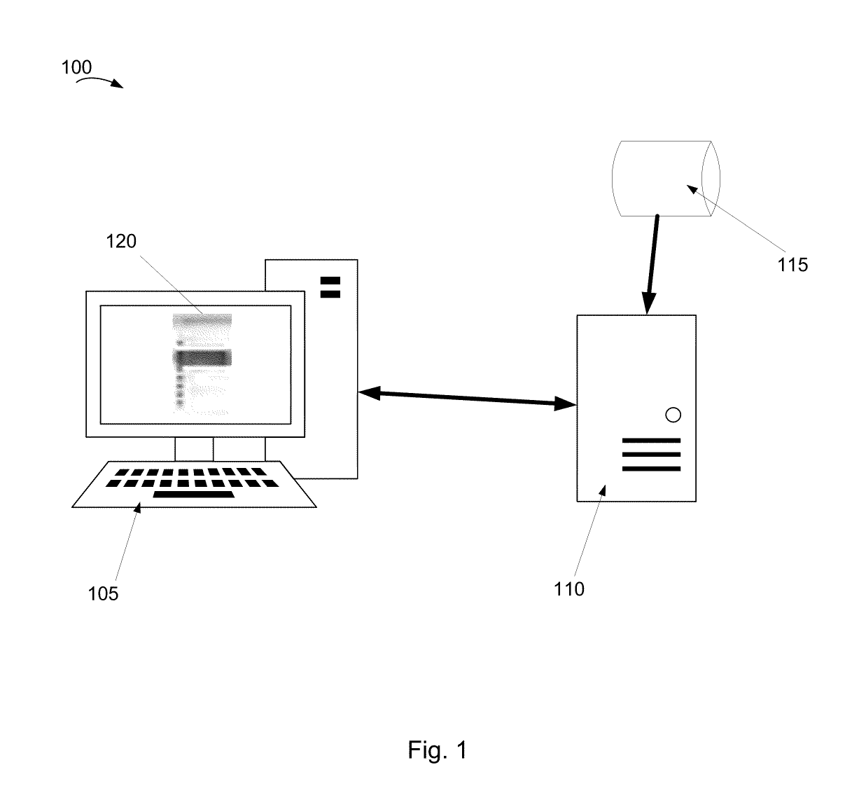

FIG. 1 illustrates an exemplary system for consumer review ranking 100, in accordance with an embodiment of the present invention. A consumer review ranking system 100 may comprise of a user interface 105, a server 110 and a database 115. User interface 105 may have a means of receiving user input and/or business review information for upload. User interface 105 may also display a graphical user interface 120 to allow a user to edit and/or navigate through business reviews submitted to database 115.

During typical operation, a user may upload and/or retrieve consumer reviews on consumer review ranking system 110. A user may first upload a consumer business review information and/or submit user commands on user interface 105 by virtually any means such as, without limitation, keyboards, touch screens, voice commands, retina display, haptic display, sign language, and a computer mouse. Information and/or commands submitted by the user may then be sent to server 110 which may access database 115 for retrieving and/or storing consumer review information. Server 110 may execute algorithms from a non-transitory computer readable medium to process consumer review information and generate a review ranking and/or review statistics and metadata. Consumer reviews and/or processed consumer review information may be presented to a user within graphical user interface 120 on user interface 105.

It may be appreciated by a person with ordinary skill in the art, in light of and in accordance with the teachings of the present invention, that user interface 105 may be virtually any computing device. User interface 105 may be, without limitation, a smartphone device, a desktop computer, laptop computer, a tablet, a phablet, automobile control panel, aviation control panel, train control panel, billboard display interface, cinema screen display interface, television interface, PDA interface, virtual reality interface, wearable watch interface, wearable ring interface, and a camera interface.

It may be appreciated by a person with ordinary skill in the art, in light of and in accordance with the teachings of the present invention, that one or more elements of consumer review ranking system 100 may be one or more devices. In an alternative embodiment of the present invention, user interface 105 and server 110 may be one physical device. In yet another alternative embodiment of the present invention, database 115 may comprise of a plurality of heterogeneous databases.

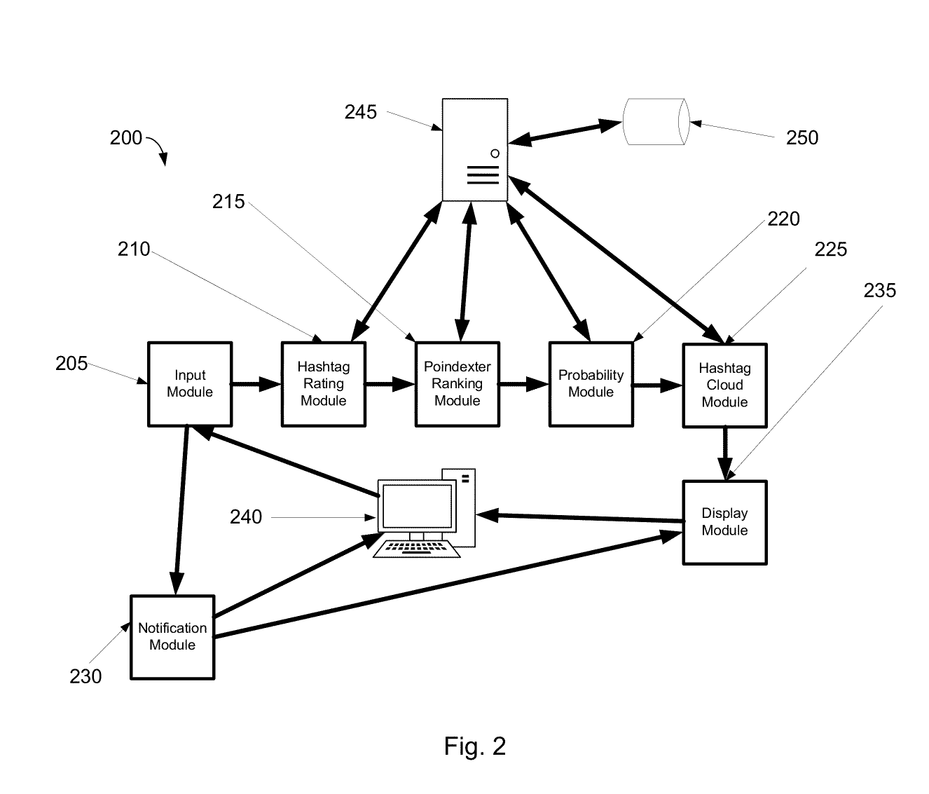

FIG. 2 illustrates the architecture of an exemplary system for consumer review ranking 200, in accordance with an embodiment of the present invention. Consumer review ranking system architecture 200 may comprise of an input module 205, a hashtag rating module 210, a Poindexter ranking module 215, a probability module 220, a hashtag cloud module 225, a notification module 230, and a display module 235. Input module 205 has a means to receive input form a user such as, but not limited to, a computer terminal 240, a hardware peripheral, and/or a mobile computing device. Hashtag rating module 210 has a computing means such as, without limitation, computer terminal 240 and/or server 245. Poindexter ranking module 215 has a computing means such as, without limitation, computer terminal 240 and/or server 245. Probability module 220 has a computing means such as, without limitation, computer terminal 240 and/or server 245. Hashtag cloud module 225 has a computing means such as, without limitation, computer terminal 240 and/or server 245. Server 245 typically stores data in a database 250 such as, without limitation, local hard disk drives, networked cloud services, or detachable memory within the database 250.

During typical operations, input module 205 receives input for a consumer review on a business listing page. The input typically includes, without limitation, a recent video, live streaming video, photo, or audio reviews of a specific business location or entity. It should be noted that prior to posting a video, live streaming or photo review, in some embodiments, the user may be prompted to select a location or business entity, and the review could be attached to that specific business entity. Such an embodiment may employ a timestamp of each image or video recording to correspond with the listing, which could then be approved or denied for posting based, at least in part, on the time in which the video or photo was shot, which, in turn, might, at least in part, be used to determine the placement and order of the review. The multimedia input is typically associated with a keyword or hashtag to describe the business using photos, photo memes, video or audio and is typically limited to 24 characters with no spaces, however, those of ordinary skill in the art may recognize that the number of characters may be adjusted. It should be noted that a higher character limit is possible, however, typically it is preferred to not allow whitespace characters. Input module 205 may pass the keyword or hashtag to hashtag rating module 210. The keywords/hashtags received typically are rated based on how many consumers use the same keyword/hashtag to describe their experience. It is contemplated that the more times the keyword/hashtag is used, the keyword/hashtag grows, in concordance with the popularity of the keyword. It is contemplated that one of ordinary skill in the art, may design the system to map similar keywords/hashtags to one keyword/hashtag. It is contemplated that the keywords may need to be designed to match OR be similar; meaning a synonym that references the word being used to describe a consumers experience. It is contemplated that synonyms of the keyword may carry more significance, which might provide a consumer with either an overall positive, neutral or negative experience. One aspect of the present embodiment is that the keywords may be allowed to grow as the words match. Further, consumers that agree with another consumer's review typically have the option to click, tap, swipe, or any other input means, to agree. Similarly, consumers that disagree may also interact in the same manner to show disagreement. The news feed of the consumer review of the business is typically updated automatically and in real-time. Consumer posts are typically removed after a 120-day period. New consumer posts are accepted only within a 30-day window of when the consumer visited a given location. The present embodiment may employ a photo or video timestamp to determine the date and time of each image or video in order to determine the expiration of a video or photo within the exemplary 30/120 day window for a consumer review.] In an alternative embodiment, a mobile application allows you to check-in to particular event or place using simplistic icons and anonymously using group chat live streaming video with other consumers at your particular location. In an alternative embodiment, consumers at different locations may live chat with other consumers that are not present at the same location. It is contemplated that user profiles are semi-anonymous such that an avatar is visible, but usernames are not.

Hashtag rating module 210 sends keyword/hashtag data to Poindexter ranking module 215. Poindexter ranking module 215 typically uses a review experience algorithm to assign a numerical weighting value to linked keywords/hashtags posted by a consumer to review, without limitation, a business, person, product, service, or event. The review algorithm may be expressed by the formula, P(experience keyword)=p±z_(α/2)√((p(1−p))/n), where [P represents the level of experience, X represents the amount of people that said they had a specific level of experience, and N represents the total amount of reviews posted under that business listing. The review algorithm typically generates a Poindexter Rank, which may be a range of percentage confidence ranking of how likely another consumer might share the same experience.

Poindexter ranking module 215 sends the range of percentage confidence rankings for a given keyword/hashtag to probability module 220. Probability module 220 generates an Experience Probability Score, which is typically the average of the range of percentage confidence ranking. The Experience Probability Score typically represents on average what the person's chance of having a given experience based on the keyword/hashtag.

Probability module 220 sends the Experience Probability Score to hashtag cloud module 225. It is contemplated the Experience Probability Score may be applied as the font size of the keyword/hashtag in the word cloud. A hashtag cloud generator typically measures the size and spacing of keywords/hashtags in the cloud. A font system adjusts based on popularity, count, or frequency of a keyword/hashtag being used.

Hashtag cloud module 225 outputs the resulting word cloud to display module 235. Consumers having a mobile device such as, without limitation, a smartphone or tablet, may be alerted by geographic location (geo-location) alerts. A consumer within the vicinity of an entity such as, without limitation, a business, event, or person, may be alerted by their mobile device about the corresponding entity. Notification module 230 will typically send information to computer terminal 240 and display module 235 to alert the consumer.

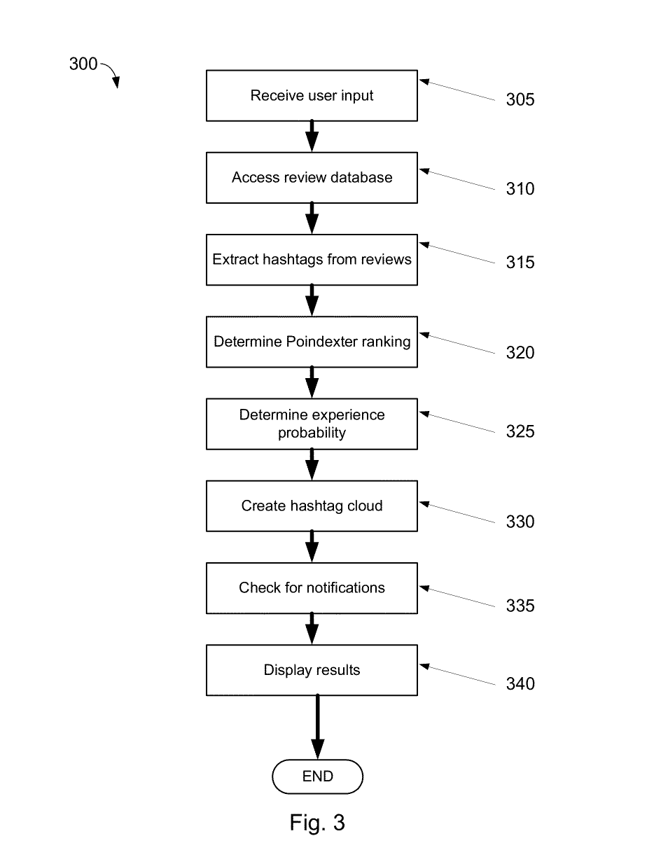

FIG. 3 is a flow chart illustrating an exemplary process for consumer review ranking 300, in accordance with an embodiment of the present invention. Consumer review ranking process 300 begins with receiving user input at step 305. After the user provides input, the consumer review ranking system accesses a review database at step 310. The review database extracts hashtags from reviews at step 315. Extracted hashtags are used to determine a Poindexter ranking at step 320. The Poindexter ranking may be used to derive an experience probability score at step 325. The experience probability score determines the creation of the hashtag cloud at step 330. The hashtag cloud checks for notifications based on geo-location of a consumer to a specific entity at a specific location at step 335. The results of the notifications are displayed on a terminal or server at step 340.

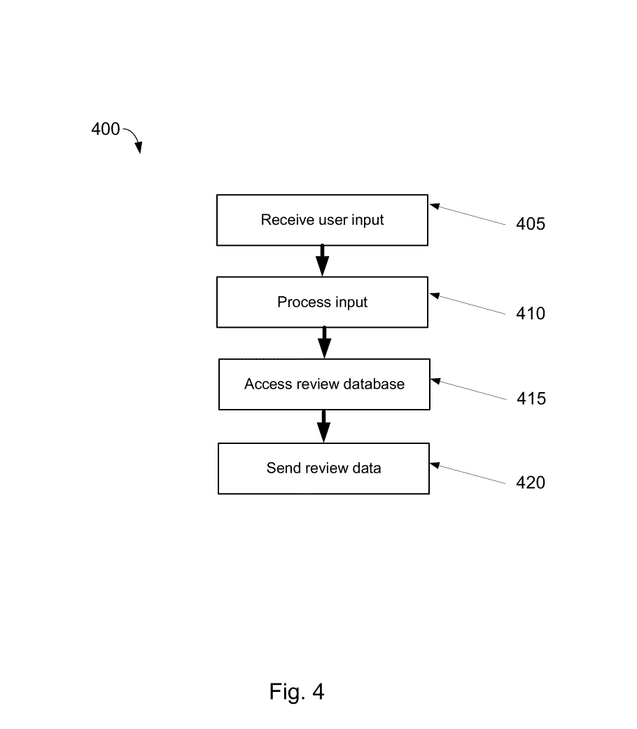

FIG. 4 is a flow chart illustrating an exemplary process for user input in an input module, in accordance with an embodiment of the present invention. A user input process 400 begins with receiving a user input at step 405. Once the input has been entered, the input is processed at step 410. After the input is processed, a keyword/hashtag review database is accessed at step 415. Once the keyword/hashtag has been located, the data is sent at step 420.

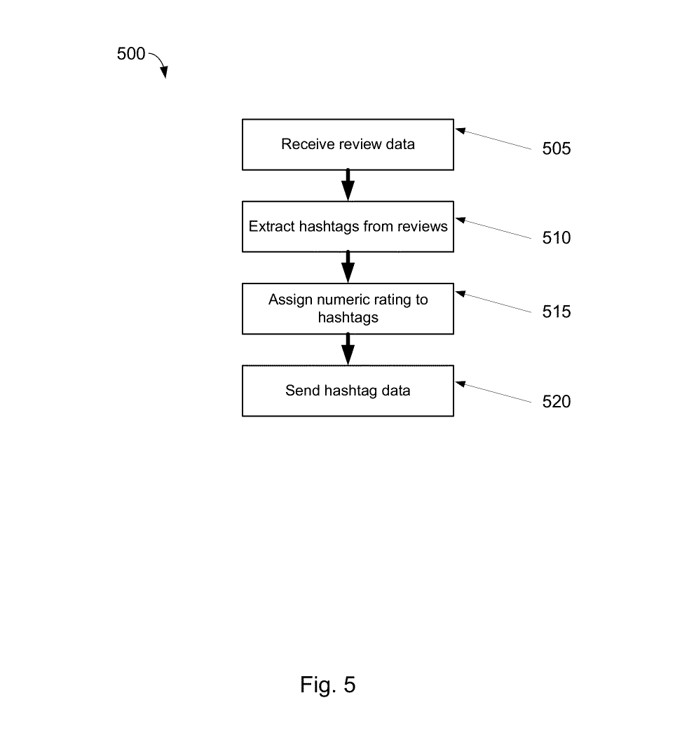

FIG. 5 is a flow chart illustrating an exemplary process for hashtag rating in a hashtag rating module, in accordance with an embodiment of the present invention. A hashtag rating process 500 begins with receiving review data at step 505. Keyword/hashtags are extracted from the review data at step 510. The keywords/hashtags are assigned a numeric rating, based on how many people used the keyword/hashtag, at a step 515. The numeric rating is then sent at step 520.

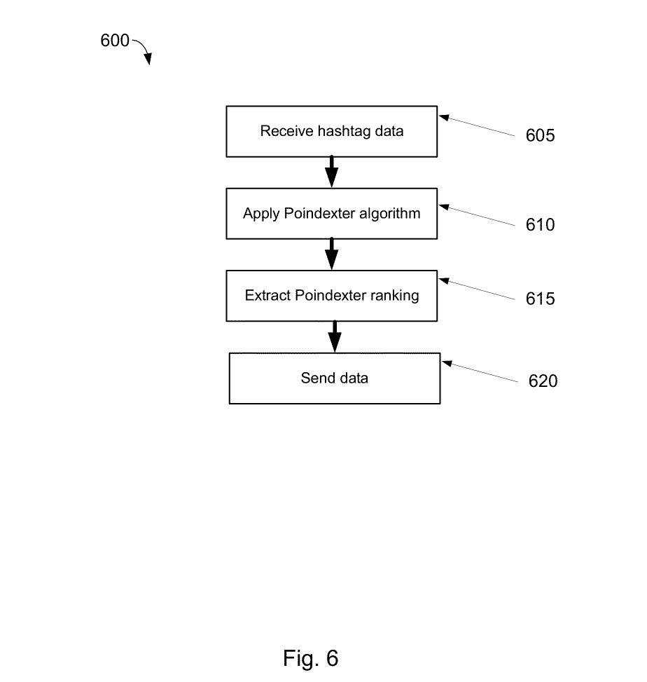

FIG. 6 is a flow chart illustrating an exemplary process for Poindexter ranking in a Poindexter ranking module, in accordance with an embodiment of the present invention. Poindexter ranking process 600 begins with receiving hashtag data at step 605. Upon receipt, the Poindexter algorithm is applied at step 610. The Poindexter ranking is extracted at step 615. The Poindexter ranking is sent at step 620.

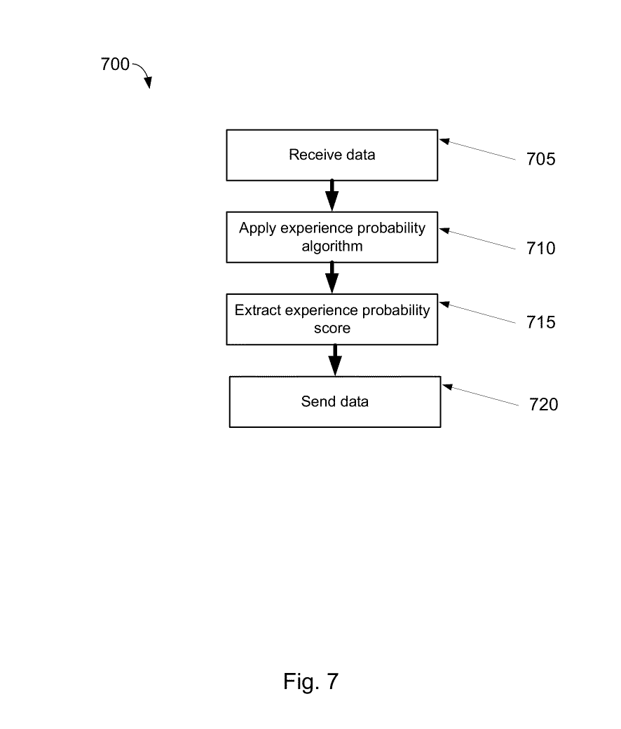

FIG. 7 is a flow chart illustrating an exemplary process for determining an experience probability in a probability module, in accordance with an embodiment of the present invention. The experience probability determination process 700 begins with receiving Poindexter ranking data at step 705. The experience probability algorithm averages the range of Poindexter ranking data at step 710. The experience probability score is extracted at step 715. The experience probability score is sent at step 720.

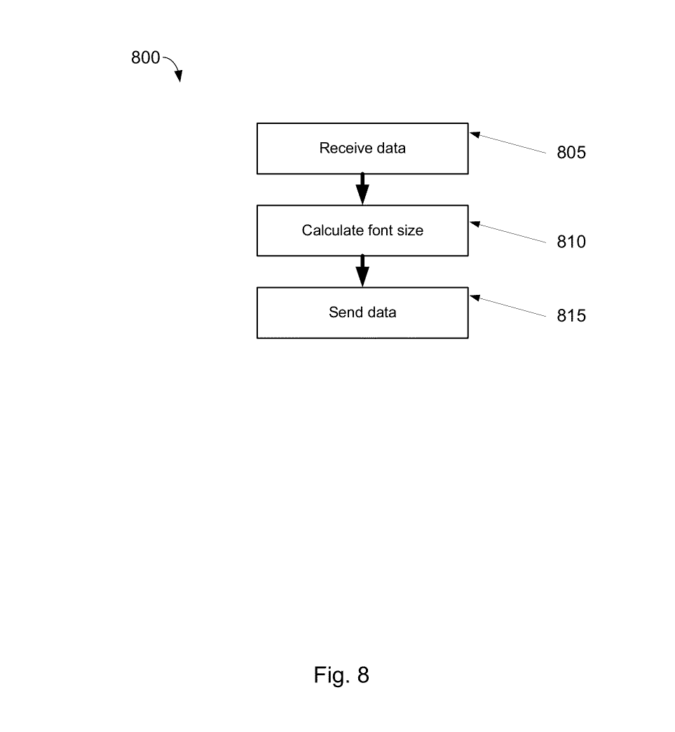

FIG. 8 is a flow chart illustrating an exemplary process for hashtag cloud generation in a cloud generation module, in accordance with an embodiment of the present invention. The hashtag cloud generation process 800 begins with receiving the experience probability score at step 805. The experience probability score is used to calculate the font size in the word cloud at step 810. The font size is sent at step 815.

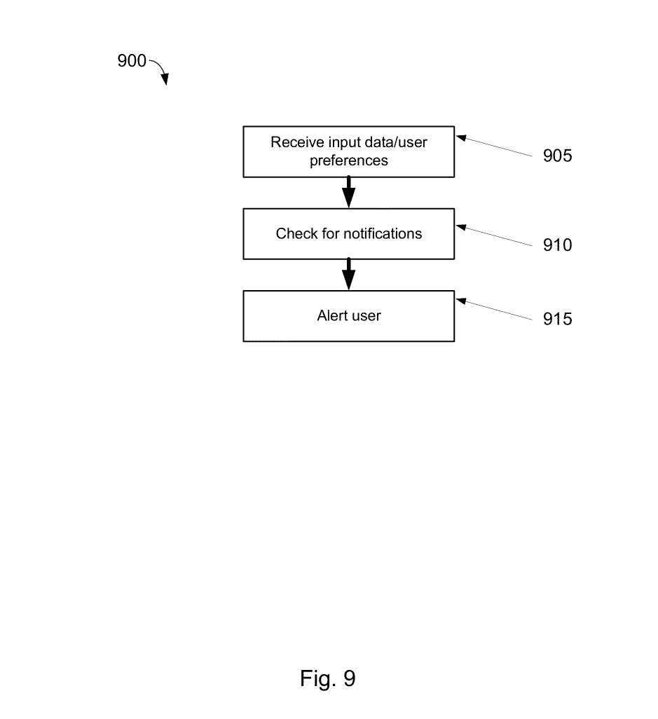

FIG. 9 is a flow chart illustrating an exemplary process for user notification in a notification module, in accordance with an embodiment of the present invention. The user notification process 900 begins with data input or user preferences such as, without limitation, geo-location, keyword/hashtag, or user check-in are determined at step 905. Whether notifications need to be sent typically is checked at step 910. If notifications need to be sent, the user is alerted at step 915.

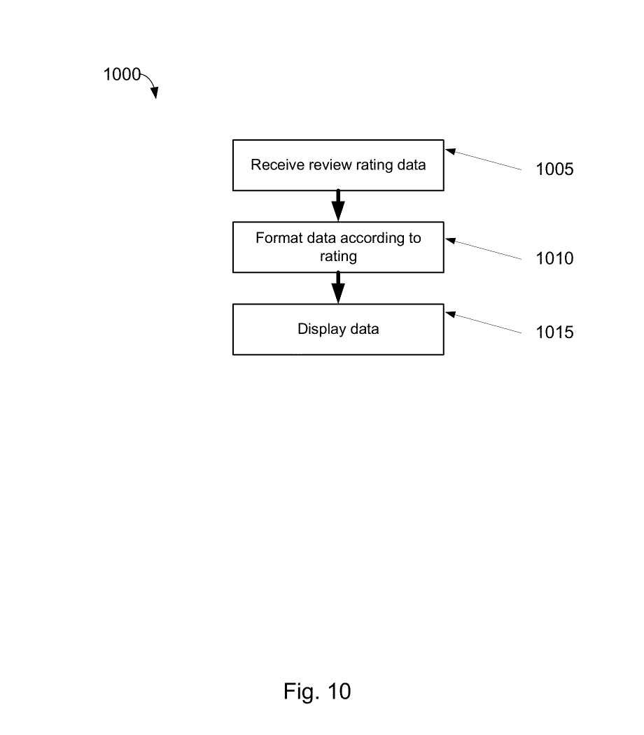

FIG. 10 is a flow chart illustrating an exemplary process for displaying consumer reviews in a display module, in accordance with an embodiment of the present invention. The consumer review display process 1000 begins with receipt of review ratiNg data at step 1005. The data is formatted based on the rating such as, without limitation, font size, color, bolding, underlining, or italicizing, animation, visual effects, sound effects at step 1010. After being formatted, the data is displayed at step 1015.

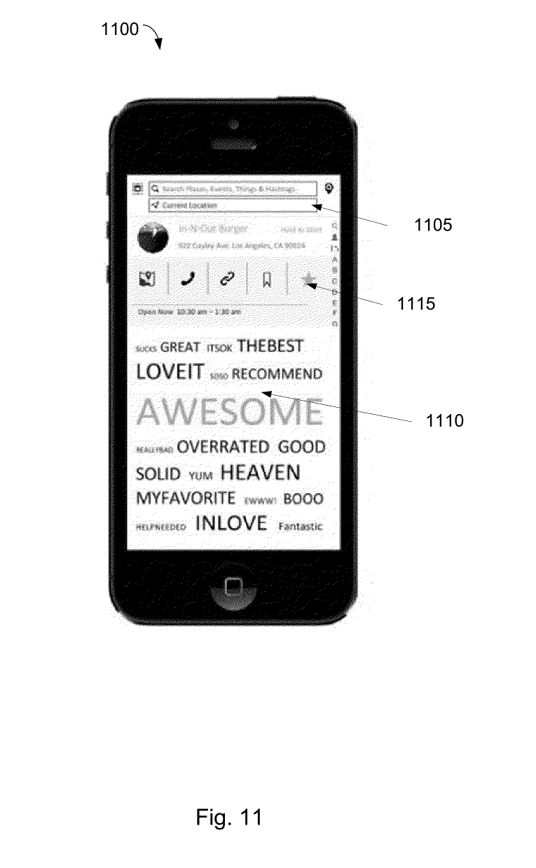

FIG. 11 illustrates an exemplary user interface for consumer review, in accordance with an embodiment of the present invention. User interface for consumer hashtag/keyword review rating system 1100 may be comprised of a geo-location field 1105, hashtag/keyword that is the presumed best word to describe the business listing 1110 and keyword/hashtag cloud page 1115. Geo-location field 1105 typically updates automatically and in real-time. The automatic update process may push notifications to a consumer's wireless device or smartphone or tablet. Keyword/hashtag cloud page 1115 may display in real-time the best keyword to describe the business listing or entity.

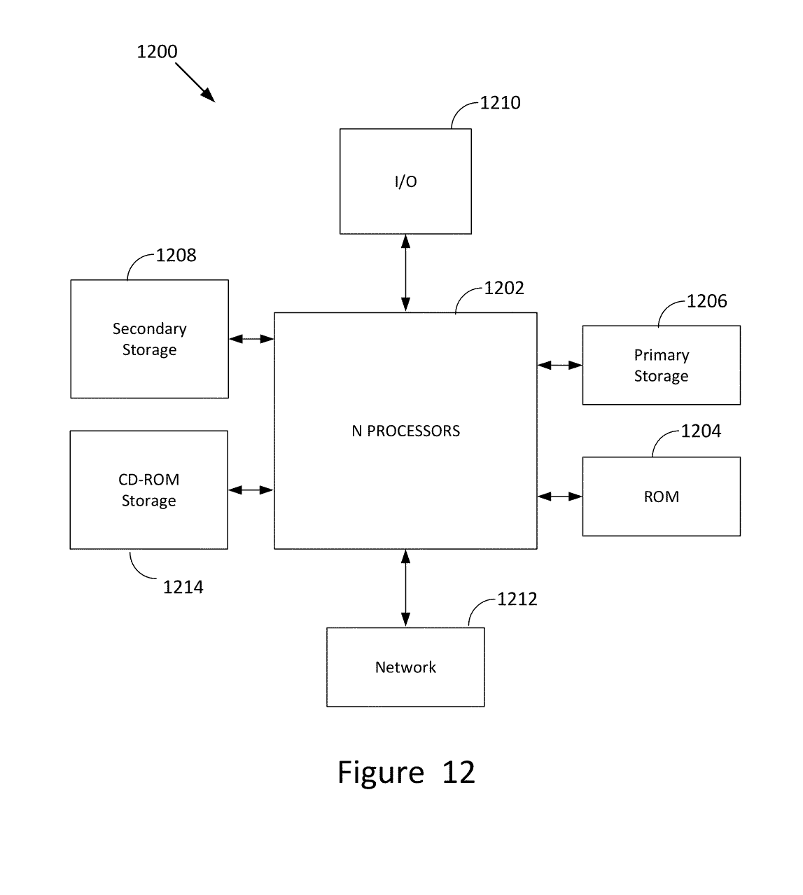

FIG. 12 illustrates a typical computer system that, when appropriately configured or designed, can serve as a computer system in which the invention may be embodied. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers (e.g., with embedded RAM/ROM) and microprocessors such as programmable devices (e.g., RISC or SISC based, or CPLDs and FPGAs) and programmable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 may also be coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 614 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications or internet network using an external connection as shown generally at 1212, which may be implemented as a hardwired or wireless communications link using suitable conventional technologies. With such a connection, it is contemplated that the CPU might receive information from the network, or might output information to the network in the course of performing the method steps described in the teachings of the present invention.

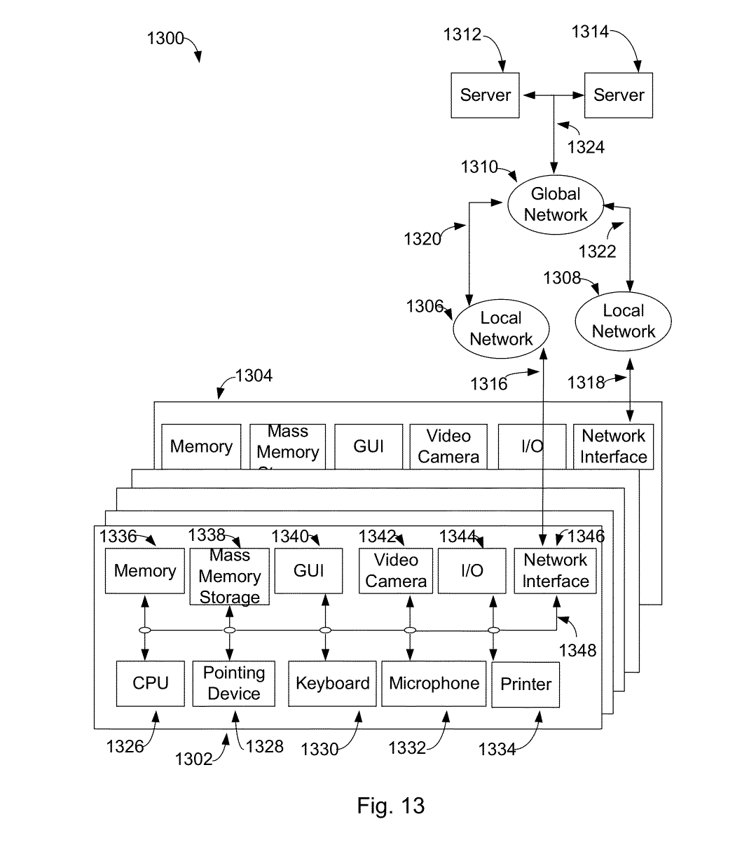

FIG. 13 is a block diagram depicting an exemplary client/server system which may be used by an exemplary web-enabled or networked system embodiment of the present invention.

A communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344, and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

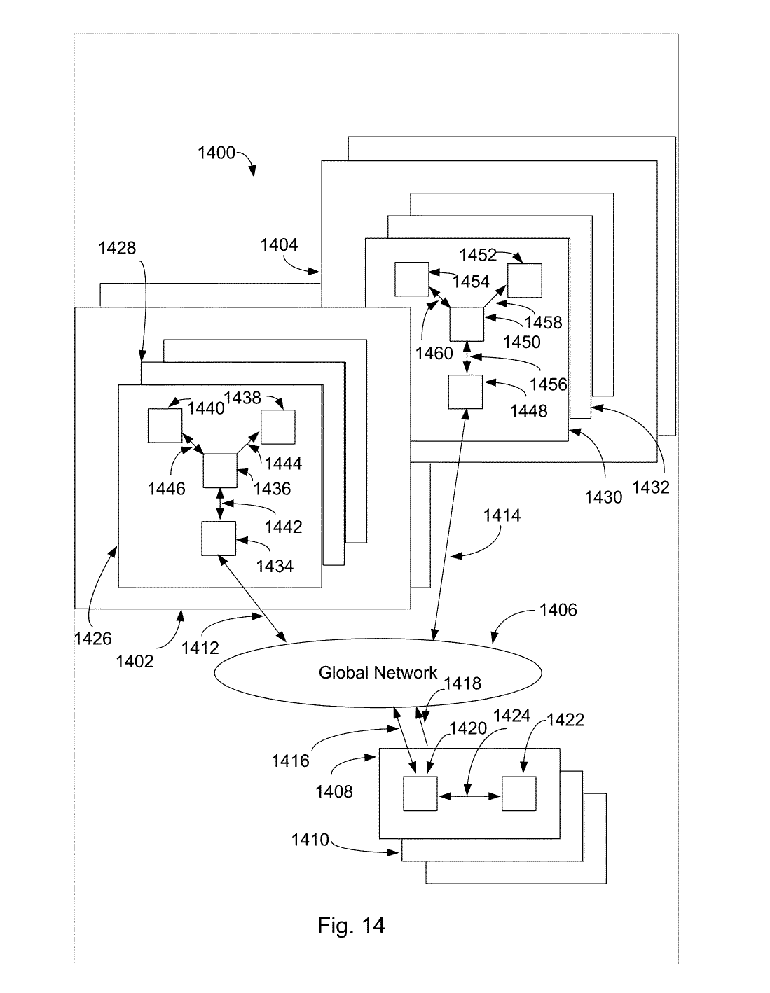

FIG. 14 illustrates a block diagram depicting a conventional client/server communication system.

A communication system 1400 includes a multiplicity of networked regions with a sampling of regions denoted as a network region 1402 and a network region 1404, a global network 1406 and a multiplicity of servers with a sampling of servers denoted as a server device 1408 and a server device 1410.

Network region 1402 and network region 1404 may operate to represent a network contained within a geographical area or region. Non-limiting examples of representations for the geographical areas for the networked regions may include postal zip codes, telephone area codes, states, counties, cities and countries. Elements within network region 1402 and 1404 may operate to communicate with external elements within other networked regions or within elements contained within the same network region.

In some implementations, global network 1406 may operate as the Internet. It will be understood by those skilled in the art that communication system 1400 may take many different forms. Non-limiting examples of forms for communication system 1400 include local area networks (LANs), wide area networks (WANs), wired telephone networks, cellular telephone networks or any other network supporting data communication between respective entities via hardwired or wireless communication networks. Global network 1406 may operate to transfer information between the various networked elements.

Server device 1408 and server device 1410 may operate to execute software instructions, store information, support database operations and communicate with other networked elements. Non-limiting examples of software and scripting languages which may be executed on server device 1408 and server device 1410 include C, C++, C# and Java.

Network region 1402 may operate to communicate bi-directionally with global network 1406 via a communication channel 1412. Network region 1404 may operate to communicate bi-directionally with global network 1406 via a communication channel 1414. Server device 1408 may operate to communicate bi-directionally with global network 1406 via a communication channel 1416. Server device 1410 may operate to communicate bi-directionally with global network 1406 via a communication channel 1418. Network region 1402 and 1404, global network 1406 and server devices 1408 and 1410 may operate to communicate with each other and with every other networked device located within communication system 1400.

Server device 1408 includes a networking device 1420 and a server 1422. Networking device 1420 may operate to communicate bi-directionally with global network 1406 via communication channel 1416 and with server 1422 via a communication channel 1424. Server 1422 may operate to execute software instructions and store information.

Network region 1402 includes a multiplicity of clients with a sampling denoted as a client 1426 and a client 1428. Client 1426 includes a networking device 1434, a processor 1436, a GUI 1438 and an interface device 1440. Non-limiting examples of devices for GUI 1438 include monitors, televisions, cellular telephones, smartphones and PDAs (Personal Digital Assistants). Non-limiting examples of interface device 1440 include pointing device, mouse, trackball, scanner and printer. Networking device 1434 may communicate bi-directionally with global network 1406 via communication channel 1412 and with processor 1436 via a communication channel 1442. GUI 1438 may receive information from processor 1436 via a communication channel 1444 for presentation to a user for viewing. Interface device 1440 may operate to send control information to processor 1436 and to receive information from processor 1436 via a communication channel 1446. Network region 1404 includes a multiplicity of clients with a sampling denoted as a client 1430 and a client 1432. Client 1430 includes a networking device 1448, a processor 1450, a GUI 1452 and an interface device 1454. Non-limiting examples of devices for GUI 1438 include monitors, televisions, cellular telephones, smartphones and PDAs (Personal Digital Assistants). Non-limiting examples of interface device 1440 include pointing devices, mousse, trackballs, scanners and printers. Networking device 1448 may communicate bi-directionally with global network 1406 via communication channel 1414 and with processor 1450 via a communication channel 1456. GUI 1452 may receive information from processor 1450 via a communication channel 1458 for presentation to a user for viewing. Interface device 1454 may operate to send control information to processor 1450 and to receive information from processor 1450 via a communication channel 1460.

For example, consider the case where a user interfacing with client 1426 may want to execute a networked application. A user may enter the IP (Internet Protocol) address for the networked application using interface device 1440. The IP address information may be communicated to processor 1436 via communication channel 1446. Processor 1436 may then communicate the IP address information to networking device 1434 via communication channel 1442. Networking device 1434 may then communicate the IP address information to global network 1406 via communication channel 1412. Global network 1406 may then communicate the IP address information to networking device 1420 of server device 1408 via communication channel 1416. Networking device 1420 may then communicate the IP address information to server 1422 via communication channel 1424. Server 1422 may receive the IP address information and after processing the IP address information may communicate return information to networking device 1420 via communication channel 1424. Networking device 1420 may communicate the return information to global network 1406 via communication channel 1416. Global network 1406 may communicate the return information to networking device 1434 via communication channel 1412. Networking device 1434 may communicate the return information to processor 1436 via communication channel 1442. Processor 1446 may communicate the return information to GUI 1438 via communication channel 1444. User may then view the return information on GUI 1438.

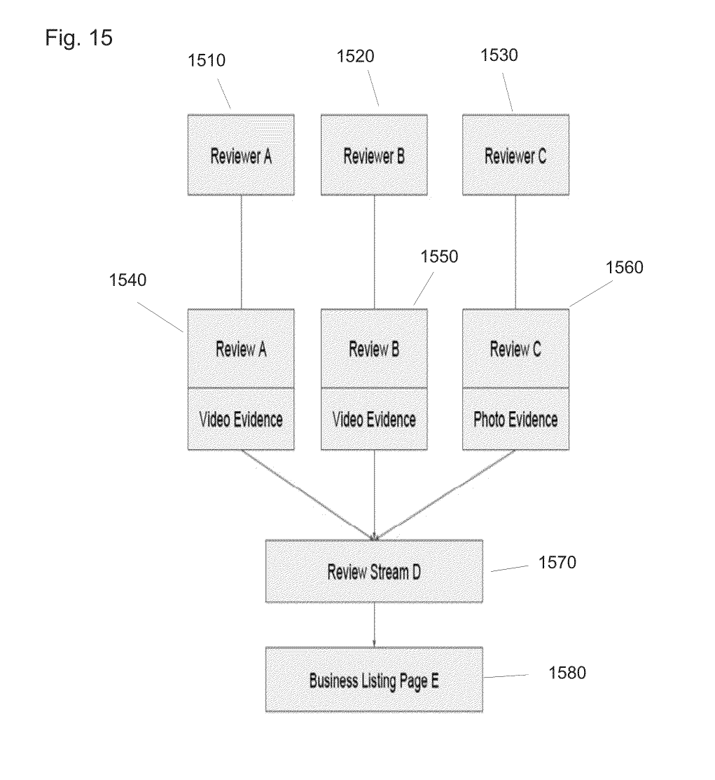

FIG. 15 illustrates an exemplary block diagram depicting exemplary keywords/hashtags in a review stream on a business listing page, in accordance with an embodiment of the present invention. An entity with a business listing page may have multiple reviewers, reviewers A-C, 1510-1530. Each reviewer may supply a review, 1540-1560, respectively, containing a keyword/hashtag associated with as evidence of the reviewer's patronage of the business such as, without limitation, photo, video, or audio. The reviews may enter a review stream 1570 or news feed for the business on the consumer review ranking system. The news feed is typically updated automatically and in real-time on the business listing page 1580. It should be appreciated by one of ordinary skill in the art, that business listing page may refer to any type of entity, event, or person.

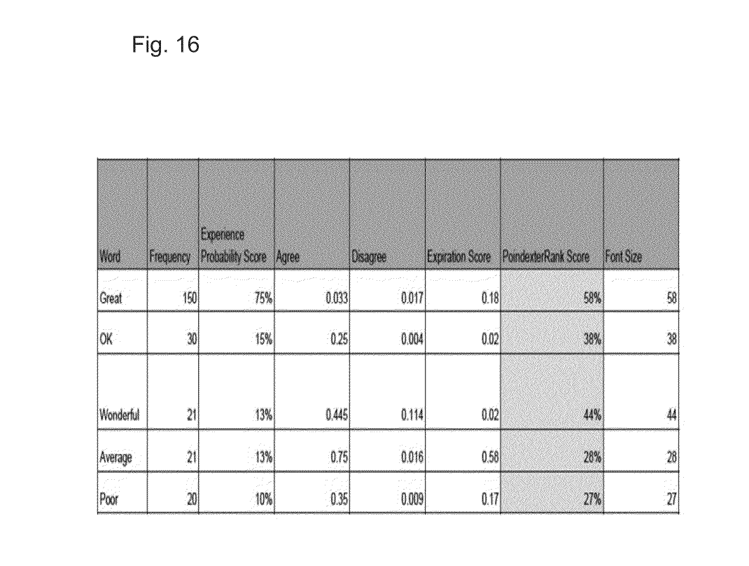

FIG. 16 is an exemplary table depicting an exemplary relationship between keyword/hashtag use and Poindexter rank, in accordance with an embodiment of the present invention. Poindexter rank may be based, and in order of priority, on Experience Probability Score, expiration score, agree score, and disagree score. Expiration score is determined by dividing the number of days a review has been listed on a business listing page by one-hundred twenty (120). It is contemplated the expiration score assists in degrading the value of older reviews to prevent newer consumers from going to a business that has likely changed as time passes. The agree or disagree score carries little weight in the Poindexter rank score due to some consumers not having actually visited a business, but providing an agree or disagree score regardless.

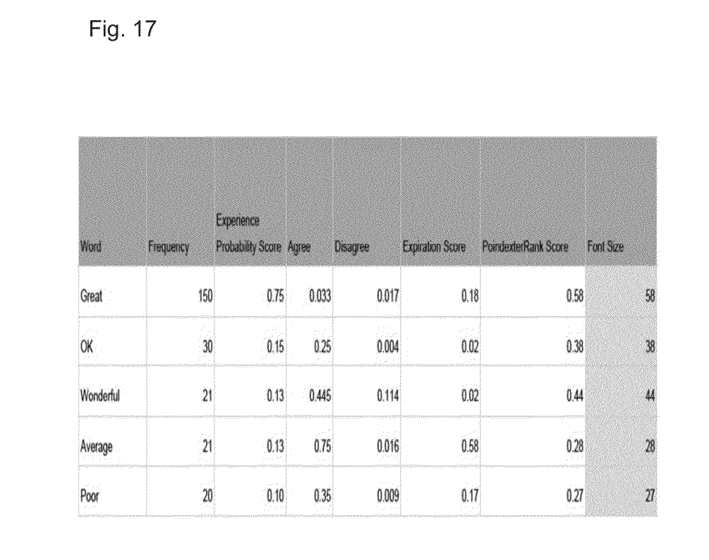

FIG. 17 is an exemplary table depicting an exemplary relationship between keyword/hashtag use and font size, in accordance with an embodiment of the present invention. It is contemplated that the font size is simply the Poindexter rank multiplied by one hundred (100). The font size cannot be greater than 100 nor less than one (1).

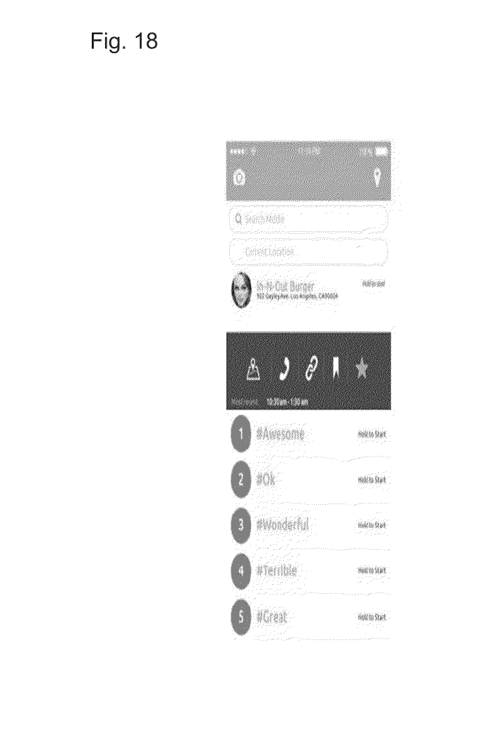

FIG. 18 illustrates an exemplary hashtag cloud, in accordance with an embodiment of the present invention.

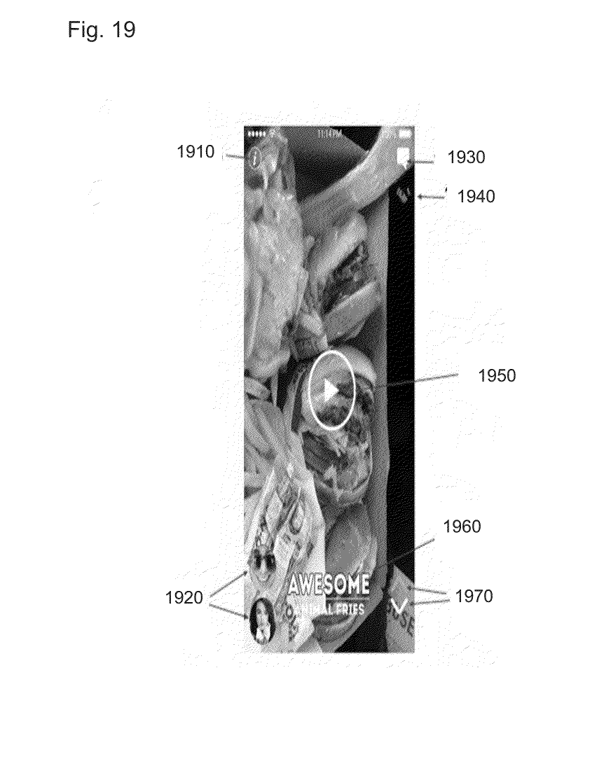

FIG. 19 illustrates an exemplary application of a hashtag as an html-encoded link, in accordance with an embodiment of the present invention. A consumer viewing the html-encoded link may be presented with a video. The video may have an information tab 1910 about the video. The consumer may see tagged friends 1920 who were referenced in the review using a keyword/hashtag to describe their experience 1960. A consumer may add comments 1930 or a consumer may use the business reconciliation platform 1940. The video may be played by selecting the play button located on the contacts page 1950. The consumer may choose to agree, by clicking up, or disagree, by clicking down via the agree/disagree button 1970.

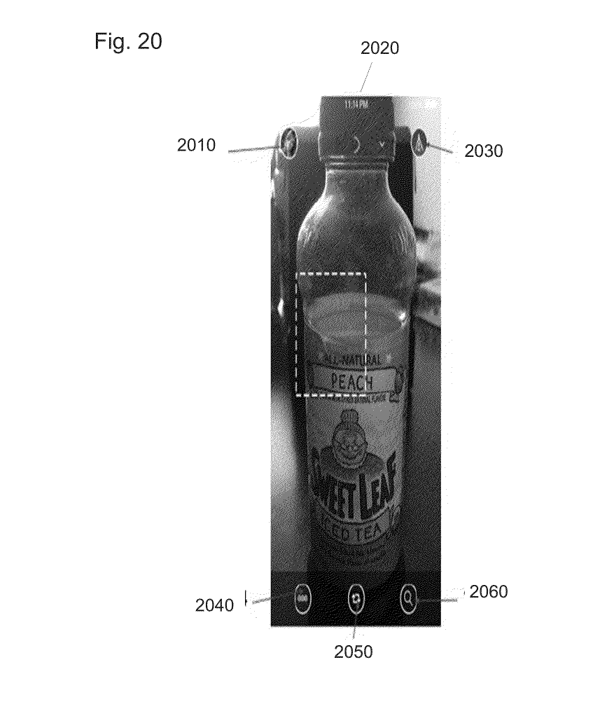

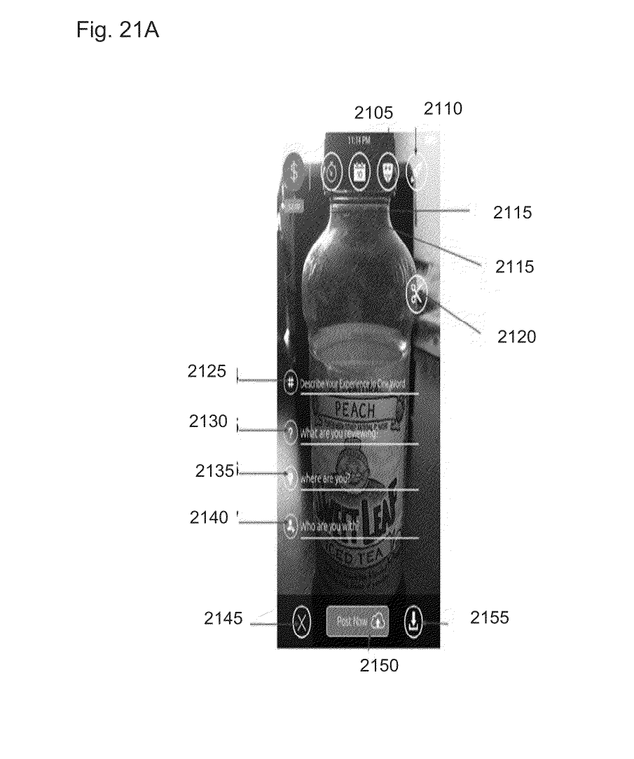

FIG. 20 illustrates a bottle as an exemplary product for review, in accordance with an embodiment of the present invention. The current consumer of a product can access their profile via the profile picture 2010. The consumer may access the most recent or featured reviews by selecting the logo 2020. The consumer may be directed to the live streaming video functionality by selecting the icon 2030. The consumer may see his/her contacts by selecting the contacts button 2040. The consumer may reverse or flip their camera view 2050; e.g., without limitation, they may be able to revise within 15 days of posting. The consumer may search for other reviews or business listings using the query button 2060.

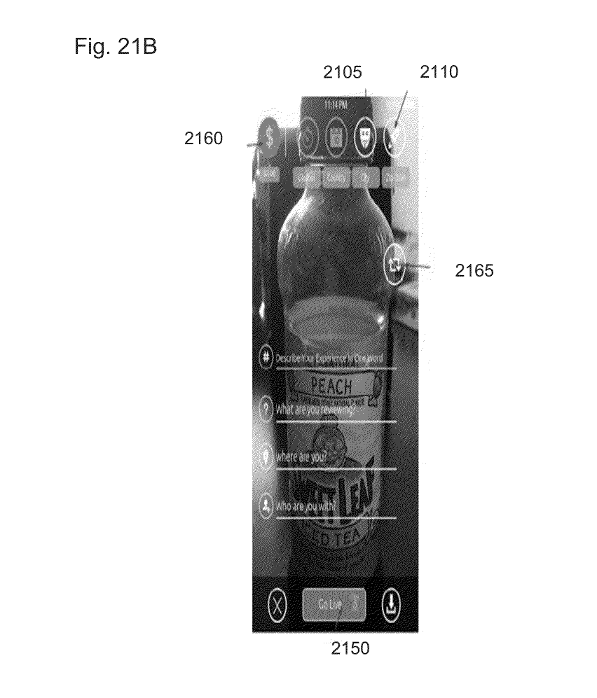

FIG. 21A-B illustrates an exemplary product review application overlaying a photo, in accordance with an embodiment of the present invention. The overlay of the photo provides different options once the edit button is engaged. The consumer may upgrade to post an anonymous review 2105. The consumer may upgrade to become a featured review within the review stream or news feed 2110. The consumer may optionally upgrade and increase the time length or length of days posted for their reviews by selecting the icons 2115. The consumer may edit the photo or video using the photo or video edit button 2120. The consumer may provide a keyword/hashtag in the keyword/hashtag field 2125. The consumer may provide a description of what he/she is reviewing using the product field 2130. The consumer may provide where they are located using the location field 2135. The consumer may provide who they are with using the companions field 2140. The consumer may cancel posting using the cancel post button 2145. The consumer may post using the post button 2150. The consumer may download the associated photo, video, or audio using the download button 2155. The consumer may discover a summary of the cost or total price of each and all review post upgrades 2160. The consumer may rotate or flip their camera view by selecting the icon 2165.

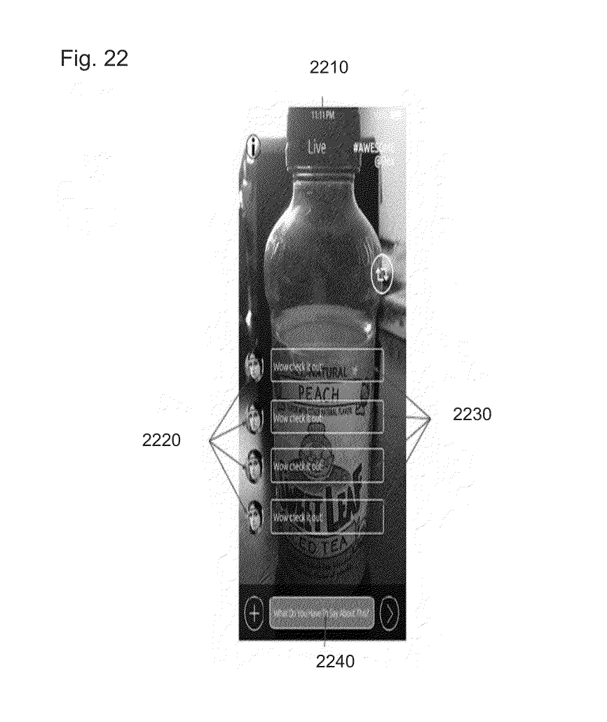

FIG. 22 illustrates an exemplary live chat application, in accordance with an embodiment of the present invention. A consumer may engage in live chat conversations with other consumers. The consumer on the current device typically is notified when a live streaming conversation or video is in progress due to the “LIVE” notification 2210. Any consumers currently on live stream will typically appear with their profile picture via an attendance indicator 2220. Any other consumer currently engaged in the conversation may have messages or audio output from their voice the output indicator 2230.

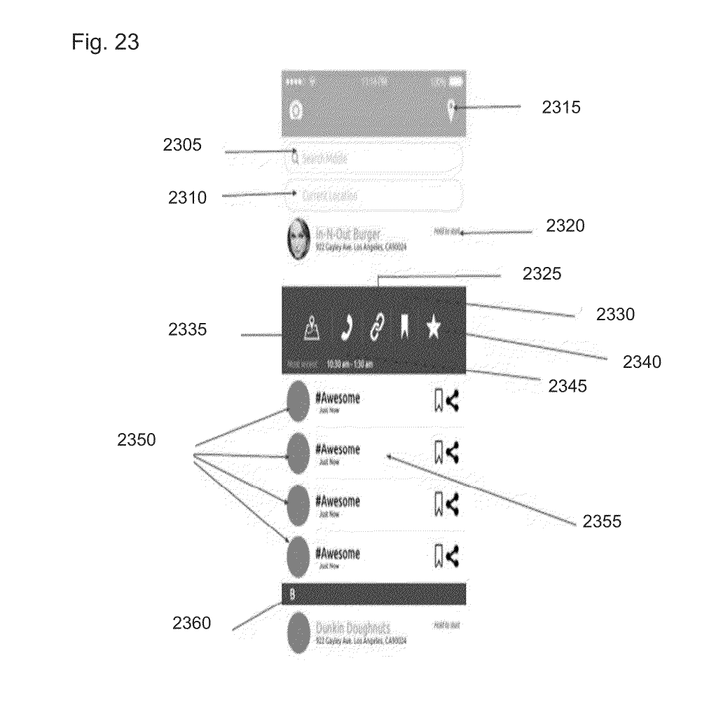

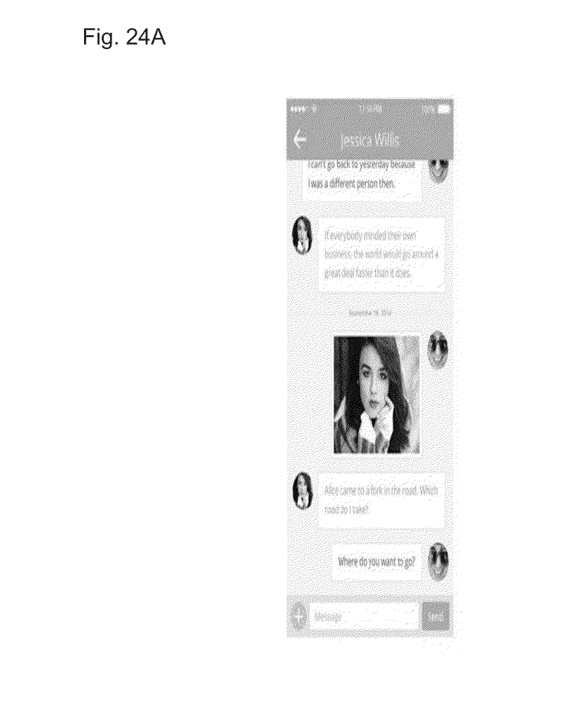

FIG. 23 illustrates an exemplary word cloud populated with keywords/hashtags and other information, in accordance with an embodiment of the present invention. A consumer viewing a business listing page may perform a search for other businesses in search field 2305. The consumer may either view or input his/her current location in location field 2310. The consumer may visit the map page by selecting this icon 2315. The consumer may begin the video and or photo review playback process 2320. The consumer may link to the business listing webpage 2325. The consumer may bookmark and save this business listing as a favorite 2330. The consumer may receive directions directly to this business listing or entity 2335. The consumer may access the hashtag/keyword rating cloud page 2340. The consumer may call the business by selecting the phone button 2345. The consumer may hold to start the review stream for the individual viewing the video or photo reviews 2350. The consumer may view a review by selecting an individual review 2355. The consumer may be presented with the business listings organized always in alphabetical order as retrieved from the search query 2360.

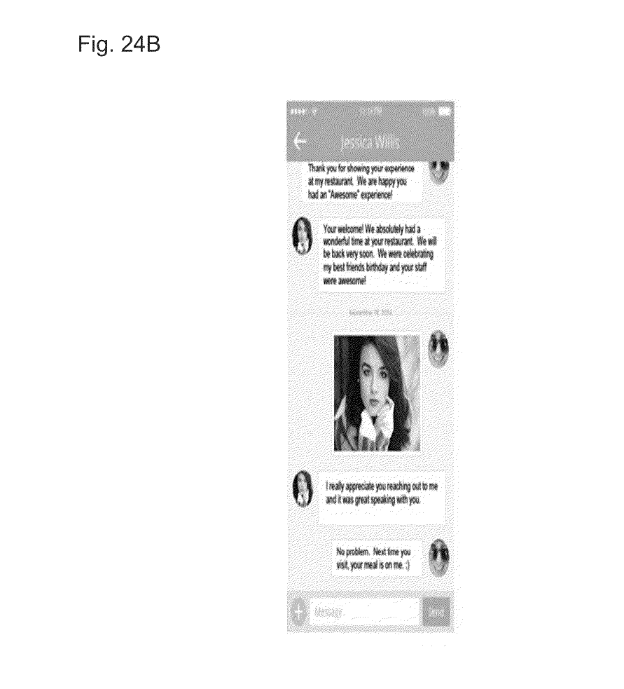

FIG. 24A-B illustrates an exemplary messaging application, in accordance with an embodiment of the present invention.

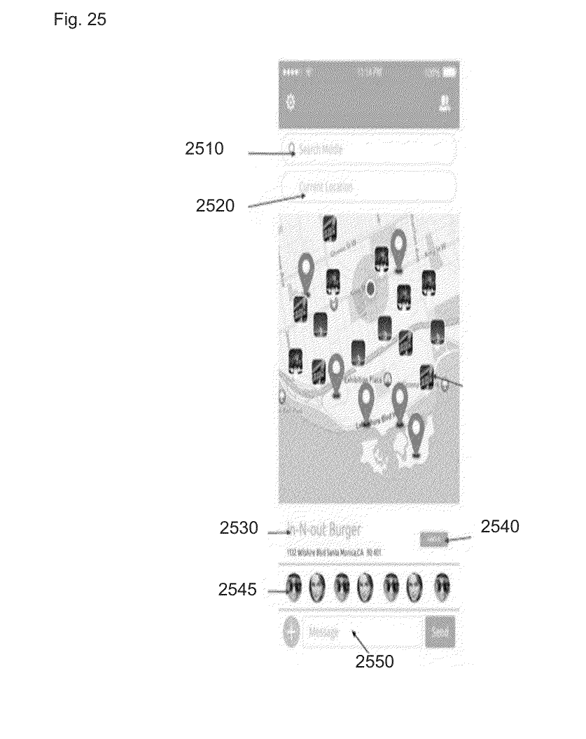

FIG. 25 illustrates an exemplary nearby consumer detection using the consumer review system, in accordance with an embodiment of the present invention. The consumer accessing a map of the surrounding area may search for businesses in the search field 2510. The consumer may search his/her location using the location field 2520. The consumer is presented with the name of the business they are currently residing at or that they wish to travel to at the name field 2530. In the present embodiment, this name be the name of the business they are currently residing at. The consumer can view more detailed information about the named business by selecting the view button 2540. It is contemplated that other consumers who are using the consumer review ranking system may be displayed in the users field 2545. The consumer may send a message to other nearby users using the messaging field 2550.

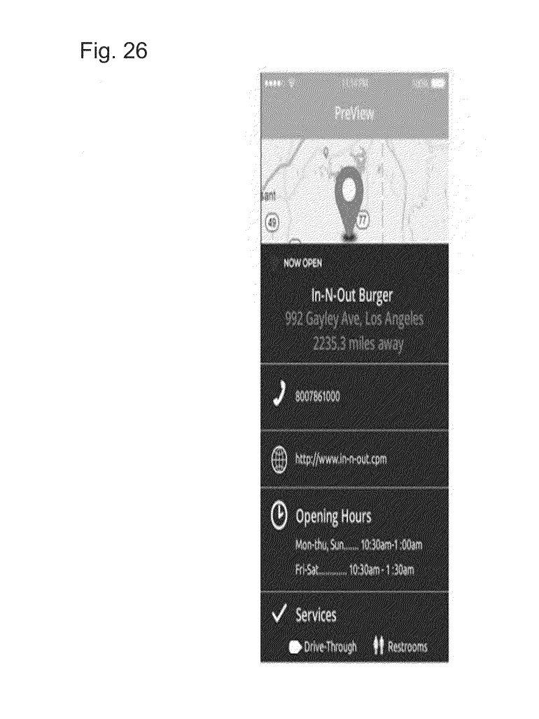

FIG. 26 illustrates an exemplary view of information for a business, in accordance with an embodiment of the present invention.

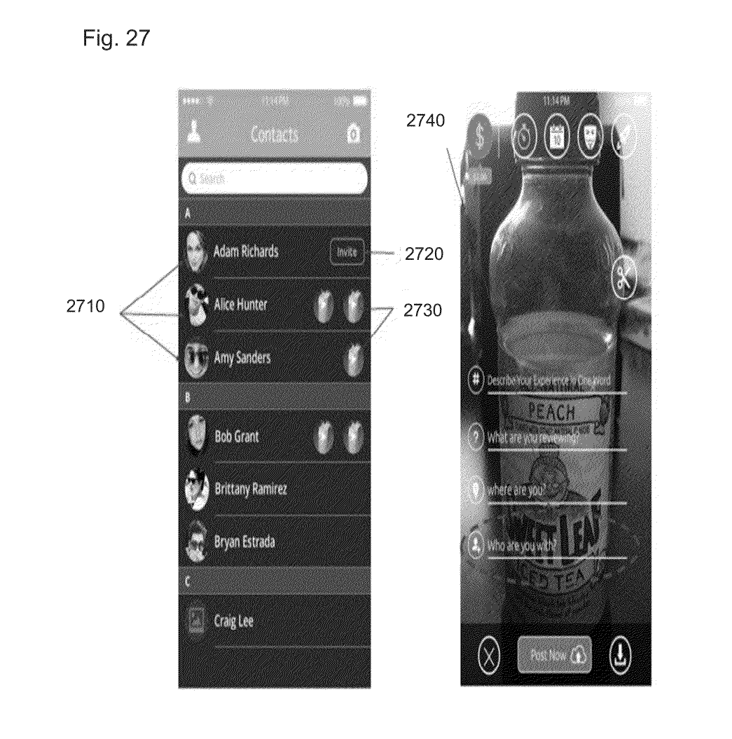

FIG. 27 illustrates an exemplary application of user tagging in a mobile application, in accordance with an embodiment of the present invention. A consumer reviewing a product, business, or event may wish to tag other people they are with at that time. A contact list 2710 may have several options. A consumer may elect to invite a friend to join the consumer review ranking system by selecting the invite button 2720. Consumers may be notified that they have been tagged in a review stream when a play button appears on the contacts photo 2730 next to the name. The more play button symbols 2730 represent friends that are able to view the video/photos that they have been tagged in directly from the contacts page. 2710 may be accessed when the consumer attempts to tag the person they are with in the person tag field 2740.

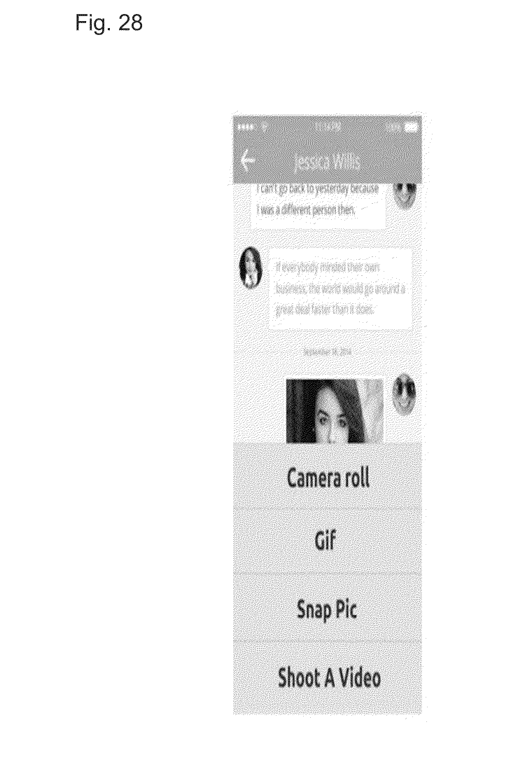

FIG. 28 illustrates an exemplary attachment of evidence in the review application, in accordance with an embodiment of the present invention.

At least some of the foregoing embodiments are contemplated to have very broad application domains. By way of example, and not limitation, recently a Wisconsin Jewelry store, Schanke-Kasten was accused of racially profiling a well known NBA basketball player. The report stated that jewelry store employee called 911 stating that they believed that John Henson of the Milwaukee Bucks basketball team was not a “legitimate” customer telling the police that Henson was “suspicious” and was concerned regarding recent robberies in the last few years. Schwanke-Kasten owner Tom Dixon offered Henson an in person apology, which Henson accepted. Although racial profiling to most people is never acceptable one of the largest issues played out on the web. Many users across the globe that took issue with this business racial profiling John Henson began to use social media sites; in specific, websites and mobile applications like Yelp to lower the overall star rating of the business as well as leave comments on the business's Yelp page. This might be an example of misappropriated use of a review site in order to cause harm to a business. Although, this business has been accused of racially profiling an athlete. Ideally, Users should not be able to leverage a review site like Yelp in order to cause harm or slander that business. Review sites should ideally not be used as advocacy sites, but used more as a source of factual evidence that an experience has taken place at a particular business, location or event. It is also very relevant that review sites develop a method of reviewing business, products or services that is fair and requires proof or evidence in order for a review to be posted, such as at least some of the foregoing embodiments are contemplated to help with, For example, such embodiments would require that in order to post a review that the one word description of a user's experience be proven by either a video, photo or audio. In such situations, users left hateful messages on review sites about the business leaving irreparable harm; users that in fact, have never visited the business, more or less had any type of experience with the the business. It is ideally incumbent on the review websites or mobile applications to limit, if not prevent, such slander and abuse. However, conventional mobile application and websites today use a similar star rating and review system that may not help against this type of slander at least due to its simple requirements of allowing people to write anything whether true or false and rate a business with any star level regardless of the authenticity of the experience. Although, many people have had issues with customers slandering the name of a business using a specific platform. The worst response has been companies attempting to sue their way out of a problem rather than providing a technological solution. The purpose of our invention is to be that solution and not only drastically increase the value of a review, but make reviews the most important factor in a purchasing decision by increasing the overall integrity of a review. By employing video, audio or photo proof of an experience as it relates to the user's keyword description of the business, product or service; over time users will tend to trust the reviews listed using this platform due to its ability to 1) measure reviews 2) provide probability or likelihood of a similar experience using PoindexterRank 3) require proof of an experience to increase the overall integrity of a review 4) Time and Relevance. As mentioned, at least some embodiment of the exemplary PoindexterRank algorithm above may provide its audience with a future experience probability or likelihood that another user will have a similar experience at the same business listing, product, service or event. It's crowdsourcing done more effectively, where a community of users provide useful information that actually can be leveraged by a technological solution helping people make sound purchasing decisions. Such embodiments may also be useful in enhancing the performance of mobile or online review results in social, user generated, community or crowdsourced based review websites or mobile applications. It is contemplated that at least some of the foregoing the algorithm and method embodiments may be broadly configured, in light of the teachings of the present invention, to be applied to various online or mobile community, crowdsourced or user generated website or mobile application that allows user to post reviews.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing consumer review ranking services according to the present invention will be apparent to those skilled in the art. Various aspects of the invention have been described above by way of illustration, and the specific embodiments disclosed are not intended to limit the invention to the particular forms disclosed. The particular implementation of the consumer review ranking services may vary depending upon the particular context or application. By way of example, and not limitation, the consumer review ranking services described in the foregoing were principally directed to commercial business review implementations; however, similar techniques may instead be applied to text recognition, automated summary generation, recreational travel services, and/or advertising services, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A computer implemented method wherein an executable program stored in a non-transitory computer-readable storage medium instructs one or more processor to perform the steps for:
obtaining at least a keyword from a user review describing an experience;
linking said keyword to said review, wherein said linked review being pointed to by a link embedded within a text or hyperlinked keyword description used to describe a business, product, service or place within said review;
obtaining at least one of a text, a recorded video, a live video, a photo and an audio proof of said experience from said linked review;
assigning a score to said linking keyword; and
processing said linked review based on a rating of said linking keyword.

2. The method of claim 1, in which said linking keyword comprises a plurality of linking keywords, each of said plurality of linking keywords is pointing to a plurality of user reviews, and wherein said step of assigning a score further comprising:
identifying a weighting factor for each of said linking keyword, wherein said weighting factor being dependent on a number of predetermined keywords matched to one or more linking keywords; and
adjusting said score of each of the one or more linking keywords based on said identified weighting factor.

3. The method of claim 1, wherein said step of assigning a score further comprising:
identifying a weighting factor for said linking keyword, wherein said weighting factor being dependent on an estimation probability that said linking keyword will be matched with other identical keywords used by different users, or agreed with; and
adjusting the score of said linking keyword.

4. The method of claim 1, in which said linking keyword comprises at least one or multiple linking keywords, each of said plurality of linking keywords is pointing to a plurality of user reviews, and wherein said step of assigning a score further comprising:
identifying a weighting factor for each of the one or multiple linking keywords, wherein the weighting factor being dependent on the most recent matching keyword used to describe a user's experience with a business, product, service or place; and
adjusting said score of each of the one or multiple linking keywords based on said identified weighting factor.

5. The method of claim 1, in which said linking keyword comprises a plurality of linking keywords, each of said plurality of linking keywords is pointing to a plurality of user reviews, and wherein said assigning step includes:
identifying a weighting factor for each of said plurality of linking keywords, the weighting factor being dependent on whether additional users agree or disagree with the keywords being used to describe the business, product, service or place; and
adjusting the score of each of the one or more linking keywords based on the identified weighting factor.

6. The method of claim 1, in which said linking keyword comprises a plurality of linking keywords, each of said plurality of linking keywords pointing to a plurality of user reviews, and wherein said step of assigning a score includes:
identifying a weighting factor for each of said plurality of linking keywords, the weighting factor being dependent on a word or phrase that means exactly or nearly the same as one or more of the plurality of linking keywords in the same language; and
adjusting the score of each of the one or more plurality of linking keywords based on said identified weighting factor.

7. The method of claim 1, wherein said step of assigning a score includes:
identifying a weighting factor for the linking keyword, wherein said weighting factor being dependent on said text, recorded video, live video, photo or audio proof of said linked keyword as it relates to the business, product, service or place; and
adjusting said score of said linking keyword based on the identified weighting factor.

8. The method of claim 1, wherein said step of assigning a score includes:
identifying a weighting factor for said linking keyword, wherein the weighting factor being dependent on a visual representation for text data, typically used to depict a keyword or one word description or expression of the experience, in which said visual representation for text data comprises a single keyword, which is distinguishable by a text color and font size, and wherein said weighting factor being further dependent on a period of time in which said review has been submitted or a duration or length of the recorded video, live video or photo; and
adjusting said score of said linking keyword based on said identified weighting factor.

9. The method of claim 1, wherein the step of processing a linked review includes:
displaying an audio, text, video or live reviews to the linked keyword as listed in a review stream or feed featured within a business listing page.

10. The method of claim 1, wherein said step of assigning a score includes:
determining said score based on at least (1) a number of textual matches of said linking keyword, (2) an importance of said textual matches, (3) a number of users that agree or disagree with the use of said linking keyword as it applies to a review and to a business listing, and (4) an expiration date of said review.

11. The method of claim 1, in which said linking keyword comprises at least a plurality of linking keywords, each of said plurality of linking keywords pointing to at least a plurality of user reviews, and wherein said step of assigning a score includes:
organizing said plurality of linking keywords in a numerical order according to their weighted score as it pertains to a review within a business listing, wherein said organized plurality of linking keywords are configured to form a keyword cloud.

12. The method of claim 1, in which said user review comprises a plurality of user reviews, wherein said step of assigning a score includes:
associating one or more of said plurality of reviews with said linked keyword, each of the reviews corresponding to said linking keyword that links to a linked business listing page; and
assigning a weight to each of said reviews; and
determining a score for said linked keywords based on a number of reviews for the linked business listing and a weight assigned to each review.

13. The method of claim 1, in which said linking keyword comprises at least a plurality of linking keywords, each of said plurality of linking keywords pointing to at least a plurality of user reviews, and wherein the step for processing said linked review includes:
organizing said plurality of linked keywords based on determined scores.

14. The method of claim 1, in which said linking keyword comprises at least a plurality of linking keywords, each of said plurality of linking keywords pointing to at least a plurality of user reviews, and wherein said step of assigning a score includes:
associating one or more reviews with each of said plurality of linked keywords, each of said reviews corresponding to one of said plurality of linking keywords that links to a business listing review;
assigning a weight to each of said reviews; and
determining a score for each of said plurality of linked keywords based on a sum of said weights assigned to said plurality of linked keywords associated with the business listing review.

15. The method of claim 1, in which said linking keyword comprises at least a plurality of linking keywords, each of said plurality of linking keywords pointing to at least a plurality of user reviews, and wherein a ranking system is configured to assign a score to a linking keyword that corresponds with a font system configured to automatically adjust said linking keyword's font size based on the frequency of use and date of expiration of said linking keyword being used to describe a business listing.

16. The method of claim 1, in which said linking keyword comprises at least a plurality of linking keywords, each of said plurality of linking keywords pointing to at least a plurality of user reviews, and wherein a list of said plurality of linking keywords being relevant in time to at least one predetermined keyword are displayed simultaneously with keyword cloud in a visual graphical user interface on a website or a mobile application business listing page.

17. A computer implemented method comprising the steps for:
obtaining a keyword from a user review describing an experience;
linking said keyword to said review, wherein said linked review being pointed to by a link embedded within a text or hyperlinked keyword description used to describe a business, product, service or place within said review, in which said linking keyword comprises at least a plurality of linking keywords, each of said plurality of linking keywords pointing to at least one or more of said plurality of user reviews;
obtaining at least one of a text, a recorded video, a live video, a photo and an audio proof of each of said linked review pointed to by each of said plurality of linking keywords;
assigning a score to each of said plurality of linking keywords; and
processing each of said plurality of linked reviews based on a rating of each of said plurality of linking keywords.

18. The method of claim 17, wherein said step of assigning a score includes:
associating one or more reviews with each of said plurality of linking keywords, each of said one or more reviews corresponding to at least one of said plurality of linking keywords that links to a business listing review;
assigning a weight to each of said reviews; and
determining a score for each of said plurality of linking keywords based on a sum of at least one or more said assigned weights.

19. An executable computer program product stored in a non-transitory computer-readable storage medium instructs one or more processor to perform the steps for:
means for obtaining a keyword from a user review describing an experience;
means for linking said keyword to a text or hyperlinked keyword description used to describe a business, product, service or place within said review;
means for obtaining at least one of a text, a recorded video, a live video, a photo and an audio proof of said experience from said linked review;
means for assigning a score or a rating to said linking keyword; and
means for processing said linked review based on said score or rating of said linking keyword.

20. The method of claim 19, wherein said means for assigning a score to said linking keyword corresponds with a font system that has the ability to automatically adjust a linking keyword's font size based on the frequency of use and a date of expiration of said linking keyword being used to describe a business listing.
